(19) United States
(12) Patent Application Publication
(10) Pub. No.: US 2008/0102156 A1
(43) Pub. Date: May 1, 2008

(54) Mold closing device of an injection molding machine with a toggle mechanism

(76) Inventor: Jui-Hsiang Wang, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/590,895

(22) Filed: Nov. 1, 2006

(51) Int. Cl. B29C 45/00

(52) U.S. Cl. 425/589; 425/450.1

(57) ABSTRACT

A mold closing device of a molding machine includes a stationary closing plate, a stationary mold-holder plate, columns secured to the stationary closing plate and the stationary mold-holder plate, a movable mold-holder plate between the stationary mold-holder plate and the closing plate, a control ring next to the movable mold-holder plate, a toggle mechanism positioned between and connected to the closing plate and the movable mold-holder plate, hydraulic cylinders, and linear sliding rail mechanisms; the hydraulic cylinders are fitted to the control ring for the control ring to make the movable mold-holder plate carry out mold closing/opening operation; the linear sliding rail mechanisms bear the weight of the control ring and the movable mold-holder plate with the movable mold-holder plat and the control ring being off the columns; the linear sliding rail mechanisms will guide the control ring and the movable mold-holder plate in operation.

### BACKGROUND OF THE INVENTION

1. Field of the Invention

The present invention relates to a mold closing device of an injection molding machine, more particularly one, which has a relatively uncomplicated structure, and convenient to use.

2. Brief Description of the Prior Art

Plastic products are very common in our daily life, e.g. cups, trays, containers, housings of various electrical appliances, and certain parts of cars and motorbikes. And, a large proportion of household appliances are either partially or completely made of plastic materials. Plastic products are usually formed by means of injection molding machines.

U.S. Pat. No. 5,252,286 dated Oct. 12, 1993 taught a closing unit for a double toggle molding apparatus 9, as shown in FIG. 7. The molding apparatus 9 includes a base 91, four parallel columns 92, a stationary die-holder plate 93, a movable die-holder plate 94, a closing plate 95, a toggle mechanism 96, a double toggle mechanism 96, and a control ring 97. The stationary die-holder plate 93 and the closing plate 95 are securely disposed on two ends of the base 91. The four parallel columns 92 are each passed through and secured to the stationary die-holder plate 93 and the closing plate 95 at two ends thereof, and they are passed through the movable die-holder plate 94 disposed between the stationary die-holder plate 93 and the closing plate 95 so that the movable die-holder plate 94 can slide on the columns 92. Furthermore, an adjusting mechanism 941 is disposed on a lower end of the movable die-holder plate 94 for adjusting lean angle of the movable die-holder plate 94 in die closing/opening operation. The control ring 97 is disposed between the closing plate 95 and the movable die-holder plate 94, and hung on the columns 92 in a slideable manner. The double toggle mechanism 96 is controlled by means of two oil hydraulic cylinders 961, and includes two toggle assemblies, which are each pivoted to the movable die-holder plate 94 at one end, and pivoted to the closing plate 95 at the other end, and connected to the control ring 97 at an intermediate connecting bar 962 thereof for controlling the movable die-holder plate 94 so as to close/open the die. The two oil hydraulic cylinders 961 are disposed on left and right sides of the control ring 97 respectively, and connected to the movable die-holder plate 94 at piston rods thereof. Furthermore, sliding sleeves 98 are secured to the movable die-holder plate 94, and positioned around the four columns 92 to slide on the columns 92 together with the movable die-holder plate 94. The movable die-holder plate 94 has oil holes 942, through which lubricating oil can be applied onto the sliding sleeves 98, as shown in FIG. 8. And, the control ring 97 will slide on the sliding sleeves 98 when driven.

The above molding apparatus has following disadvantages: When the movable die-holder plate is moved along the columns, it is prone to lean, and rub the columns in an undesirable manner because the movable die-holder plate is relatively heavy and supported only by means of the four columns; therefore, an adjusting mechanism has to be disposed under the movable die-holder plate for adjusting the movable die-holder plate to its proper position. Second, sliding sleeves have to used for allowing the movable die-holder plate and the control ring to slide on the columns smoothly. Consequently, the molding apparatus is inconvenient to use, and has a relatively complicated structure.

### SUMMARY OF THE INVENTION

It is a main object of the invention to provide an improvement on a mold closing device of an injection molding machine to overcome the above-mentioned problems. The mold closing device of the present invention includes a closing plate, a stationary mold-holder plate, columns secured to the closing plate and the stationary mold-holder plate, a movable mold-holder plate, a control ring next to the movable mold-holder plate, a toggle mechanism positioned between and connected to the closing plate and the movable mold-holder plate, hydraulic cylinders, and linear sliding rail mechanisms. The hydraulic cylinders are fitted to the control ring for the control ring to make the movable mold-holder plate carry out mold closing/opening operation. The linear sliding rail mechanisms bear the weight of the control ring and the movable mold-holder plate so that the movable mold-holder plat and the control ring are off the columns. Furthermore, the linear sliding rail mechanisms will guide the control ring and the movable mold-holder plate in operation.

### BRIEF DESCRIPTION OF THE DRAWINGS

The present invention will be better understood by referring to the accompanying drawings, wherein:

FIG. 1 is a view of the first preferred embodiment of the invention,

FIG. 2 is a view of the second preferred embodiment,

FIG. 3 is a view of the first preferred embodiment in motion,

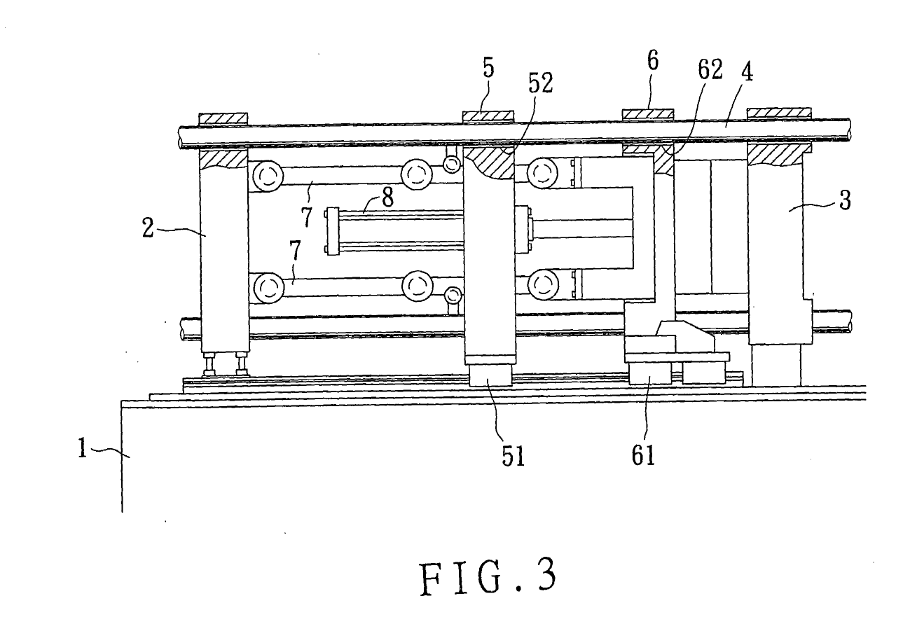

FIG. 4 is a side view of the control ring of the first embodiment,

FIG. 5 is a view of the third preferred embodiment,

FIG. 6 is a side view of the control ring of the third embodiment,

FIG. 7 is a view of the prior art, and

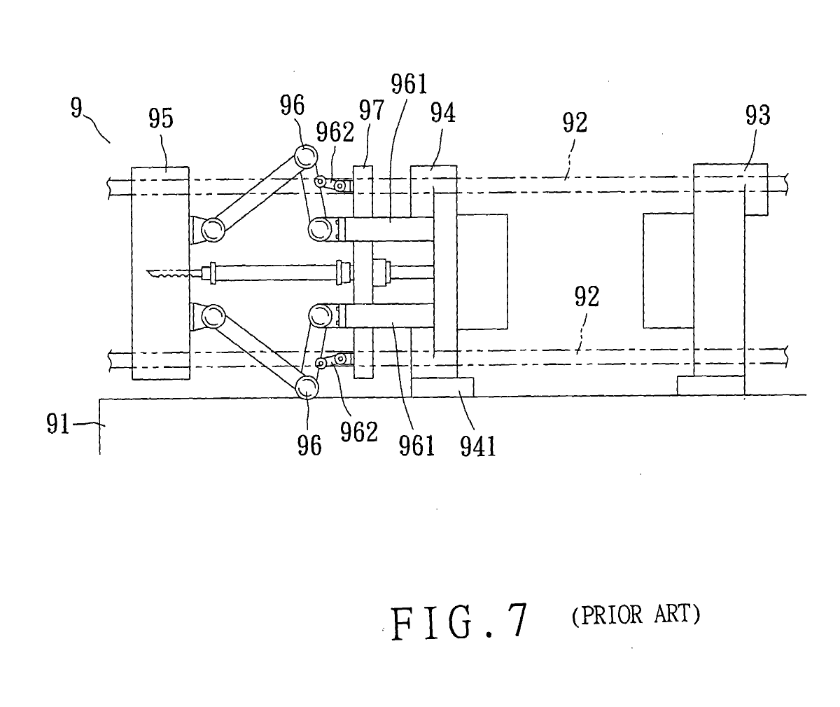

FIG. 8 is a side view of the control ring of the prior art.

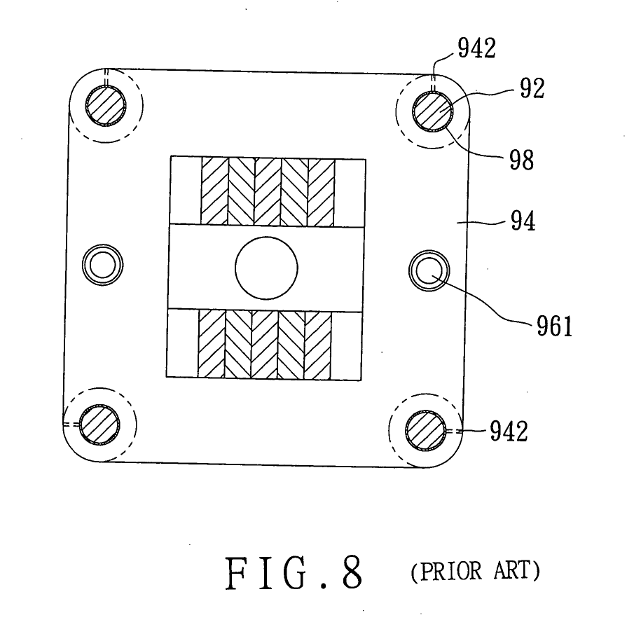

### DETAILED DESCRIPTION OF THE PREFERRED EMBODIMENTS

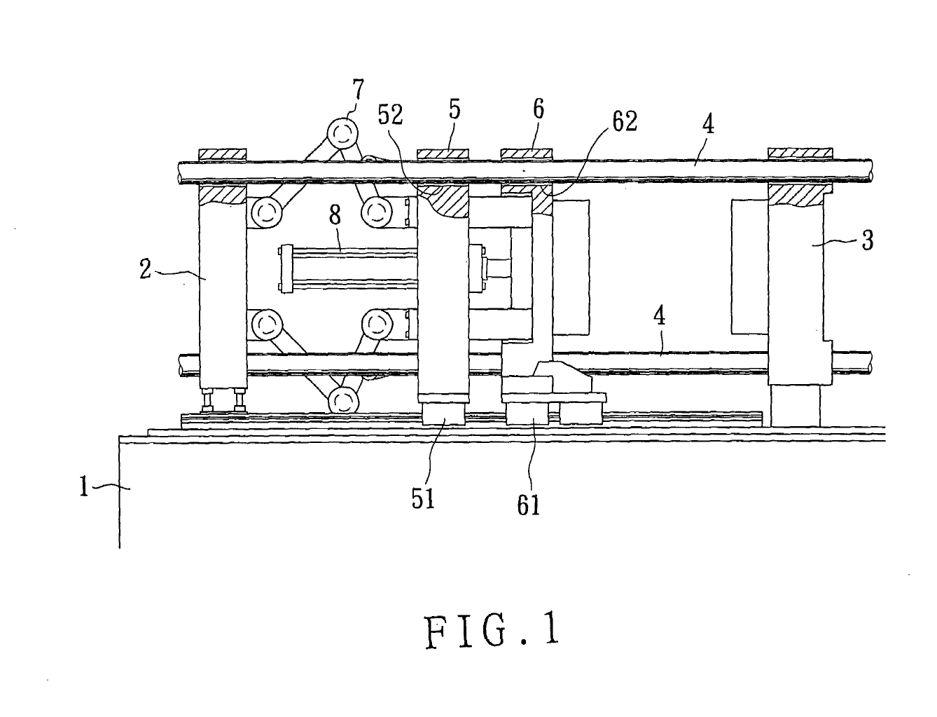

FIG. 1 shows a first preferred embodiment of a mold closing device of an injection molding machine in the present invention. The mold closing device is disposed on a bed 1 of the molding machine, and consists of a closing plate 2, a stationary mold-holder plate 3, several columns 4, a control ring 5, a movable mold-holder plate 6, linear sliding rail mechanisms 51 and 61, a toggle mechanism 7, and oil hydraulic cylinders 8.

The stationary mold-holder plate 3 and the closing plate 2 are securely disposed on two ends of the bed 1. The columns 4 are each passed through and secured to the stationary mold-holder plate 3 and the closing plate 2 at two ends thereof.

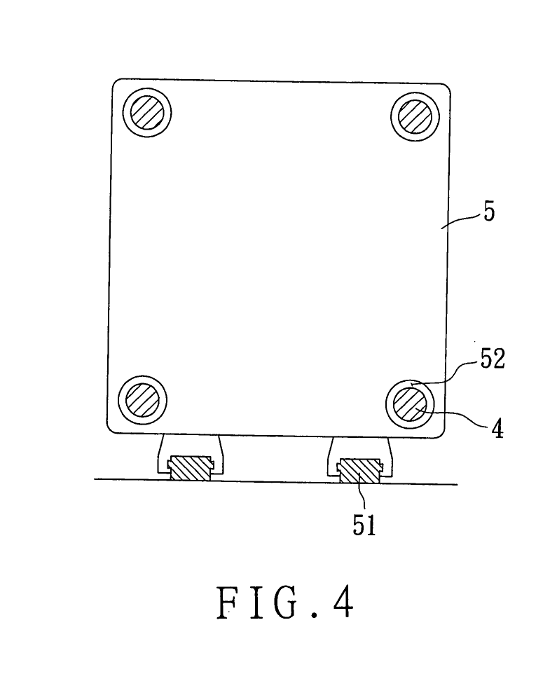

The movable mold-holder plate 6 has through holes 62, and is disposed between the stationary mold-holder plate 3 and the closing plate 2 such that the columns 4 pass through the through holes 62 without touching the movable mold-holder plate 6. The control ring 5 has through holes 52, and is disposed between the closing plate 2 and the movable mold-holder plate 6 such that the columns 4 pass through the through holes 52 without touching the control ring 5 (FIGS. 1 and 4).

The toggle mechanism 7 is disposed between and connected to the closing plate 2 and the movable mold-holder plate 6. The oil hydraulic cylinders 8 are fitted to the control ring 5, and the control ring 5 is used to make the movable mold-holder plate 6 carry out mold closing/opening operation.

The linear sliding rail mechanism 51 is disposed between the bed 1 and the control ring 5 for bearing the weight of the control ring 5. The linear sliding rail mechanism 61 is disposed between the bed 1 and the movable mold-holder plate 6 for bearing the weight of the movable mold-holder plate 6. Therefore, when the oil hydraulic cylinders 8 move the control ring 5 for the control ring 5 to make the movable mold-holder plate 6 perform mold closing/opening operation, the linear sliding rail mechanisms 51 and 61 will guide the control ring 5 and the movable mold-holder plate 6 besides bearing the weight of the control ring 5 and the movable mold-holder plate 6.

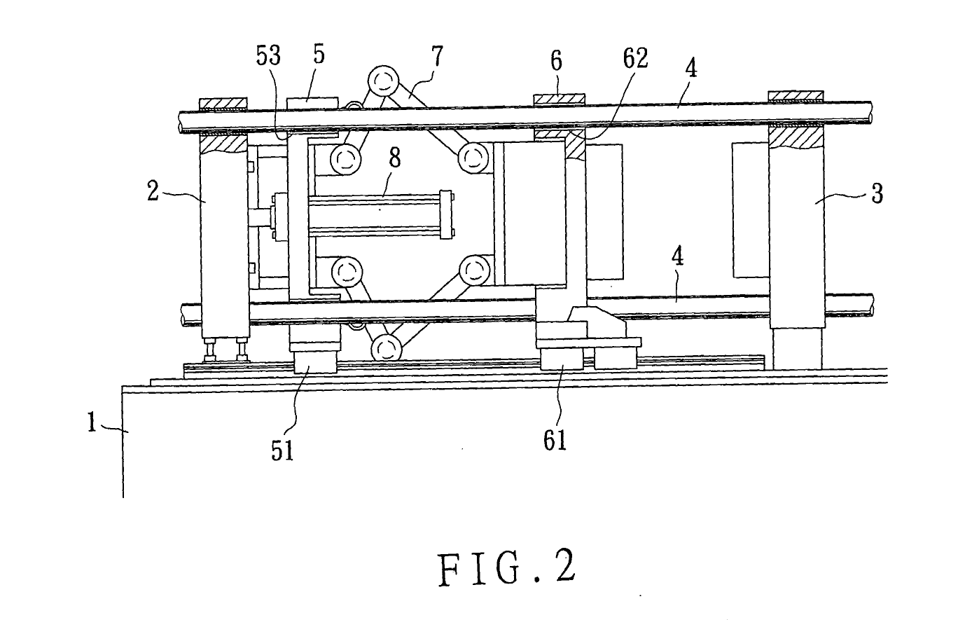

FIG. 2 shows a second preferred embodiment of the present invention, wherein the control ring 5 has gaps 53 instead of the through holes 52, and the columns 4 are passed through the gaps 53 of the control ring 5 as well as the through holes 62 of the movable mold-holder plate 6 without touching the control ring 5 and the movable mold-holder plate 6.

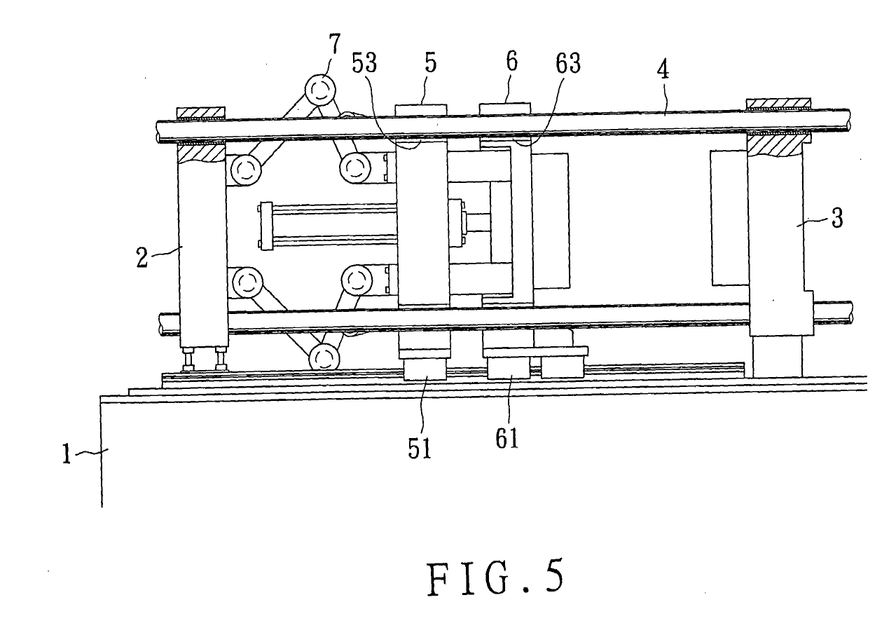

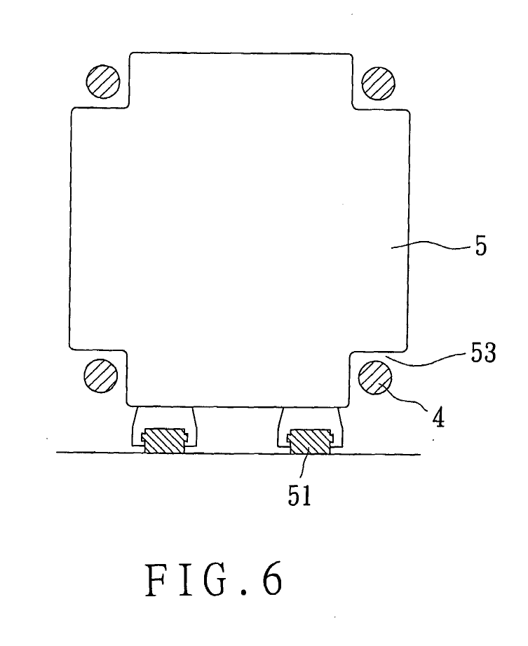

FIGS. 5 and 6 show a third preferred embodiment of the present invention, wherein the control ring 5 has gaps 53 instead of the through holes 52, and the movable mold-holder plate 6 has gaps 63 instead of the through holes 62, and the columns 4 are passed through the gaps 53 and 63 without touching the control ring 5 and the movable mold-holder plate 6.

From the above description, it can be seen that the mold closing device of the present invention has the following advantages over the conventional one described in Background:

1. It isn't necessary for the mold closing device of the molding machine of the present invention to be provided with such sliding sleeves, oil holes, and the adjusting mechanism as are used on the prior art because it has the linear sliding rails mechanisms, which bear the weight of the control ring and the movable mold-holder plate in such a way that the control ring and the movable mold-holder plate are off the columns, and which will serve as guides during linear motion of the control ring and the movable mold-holder plate.

2. Because the control ring and the movable mold-holder plate don't touch the columns in the present invention, such control rings and movable mold-holder plates as are used on the prior art also can be used on the mold closing device of the present invention after the sliding sleeves are removed. Therefore, the present invention allows the conventional mold closing device to be adapted to have a more advanced structure without having to replace the control ring and the movable mold-holder plate with new ones.

What is claimed is:

1. A mold closing device of an injection molding machine, comprising
a closing plate secured on a bed of an injection molding machine,
a stationary mold-holder plate secured on the bed,
a plurality of columns, each of the columns being passed through and secured to the closing plate and the stationary mold-holder plate at two ends thereof;
a movable mold-holder plate positioned between the stationary mold-holder plate and the closing plate in a linearly displaceable manner;
a control ring positioned next to the movable mold-holder plate in a linearly displaceable manner;
a toggle mechanism positioned between and connected to the closing plate and the movable mold-holder plate,
a first linear sliding rail mechanism, the first linear sliding rail mechanism being positioned between the bed and the control ring for bearing weight of the control ring as well as guiding the control ring with the control ring being off the columns;
a second linear sliding rail mechanism, the second linear sliding rail mechanism being positioned between the bed and the movable mold-holder plate for bearing weight of the movable mold-holder plate as well as guiding the movable mold-holder plate with the movable mold-holder plat being off the columns; and
a plurality of oil hydraulic cylinders fitted to the control ring for the control ring to make the movable mold-holder plate carry out mold closing operation and mold opening operation.

2. The mold closing device of an injection molding machine as recited in claim 1, wherein the control ring has a plurality of gaps thereon, and the columns pass through the gaps.

3. The mold closing device of an injection molding machine as recited in claim 1, wherein the control ring has a plurality of through holes thereon, and the columns pass through the through holes.

4. The mold closing device of an injection molding machine as recited in claim 1, wherein the movable mold-holder plate has a plurality of gaps thereon, and the columns pass through the gaps.

5. The mold closing device of an injection molding machine as recited in claim 1, wherein the movable mold-holder plate has a plurality of through holes thereon, and the columns pass through the through holes.
